(19) United States
(12) Patent Application Publication
(10) Pub. No.: US 2016/0267248 A1
(43) Pub. Date: Sep. 15, 2016

(54) MEDICINE ADMINISTRATION SCHEDULING

(71) Applicant: Wal-Mart Stores, Inc., Bentonville, AR (US)

(72) Inventors: Donald R. High, Noel, MO (US); Nicholas D. Rone, Bella Vista, AR (US)

(21) Appl. No.: 15/062,488

(22) Filed: Mar. 7, 2016

Related U.S. Application Data
(60) Provisional application No. 62/132,691, filed on Mar. 13, 2015.

(51) Int. Cl. G06F 19/00

(52) U.S. Cl. CPC G06F 19/3456; G06F 19/327

(57) ABSTRACT

Provided are a scheduling system and method, comprising an input port that receives from a caregiver electronic device data generated from a medication code corresponding to a prescribed medicine for a patient and that further receives medication scheduling information associated with the medication code for an administering of the prescribed medicine to the patient; a schedule adjustment module executed by a hardware processor and configured to receive and process data from the input port regarding a modification to the medication scheduling information; a notification generator that outputs an alert related to the modified medication scheduling information; and a display for displaying a schedule generated from the medication scheduling information.

### RELATED APPLICATIONS

This application claims priority to U.S. Provisional Application Ser. No. 62/132,691, filed on Mar. 13, 2015 entitled “MEDICINE ADMINISTRATION SCHEDULING”, the entirety of which is incorporated by reference herein.

### FIELD

The present concepts relate generally to the administration of medicine, and more specifically, to systems and methods for scheduling an administration of medicine.

### BACKGROUND

Modern healthcare offerings provide for the distribution of medicine from a pharmacy where a prescription is filled to a location where children can receive the prescribed medicine such as a school or home. The medicine can be administered by a caregiver, such as a school nurse.

### BRIEF SUMMARY

In one aspect, provided is a scheduling system, comprising: an input port that receives from a caregiver electronic device data generated from a medication code corresponding to a prescribed medicine for a patient and that further receives medication scheduling information associated with the medication code for an administering of the prescribed medicine to the patient; a schedule adjustment module executed by a hardware processor and configured to receive and process data from the input port regarding a modification to the medication scheduling information; a notification generator that outputs an alert related to the modified medication scheduling information; and a display for displaying a schedule generated from the medication scheduling information.

In some embodiments, the notification generator uses the medication code to retrieve a patient identification that is displayed by the scheduler notification engine with a next scheduled time for administering a dose of the prescribed medicine to the patient.

In some embodiments, the modification to the medication scheduling information includes a change in a schedule for administering the prescribed medicine in response to a change in a dose of the prescribed medicine.

In some embodiments, the scheduling system further comprises a user interface at the display that permits a user to change a quantity of the prescribed medicine, and wherein the schedule is modified to ensure that the quantity is not over or under a threshold.

In some embodiments, the notification generator outputs the alert to an electronic device of the patient when the caregiver generates event data that a dose of the prescribed medicine is administered to the patient, and wherein the alert includes a time, amount, and name of medicine.

In some embodiments, the scheduling system further comprises a comparator that compares the event data and the medication scheduling information for performance reviews.

In some embodiments, the processor processes the medication scheduling information related to multiple patients with multiple medications which need to be administered at different times.

In some embodiments, the scheduler notification engine modifies the medication scheduling information in response to different caregivers administering the prescribed medicine to the patient from different locations.

In some embodiments, the scheduler notification engine adjusts the schedule according to whether the medicine is to be administered with food.

In some embodiments, the schedule is recalculated based on when a dose of the medicine is taken.

In some embodiments, the alert includes a warning when a supply of the medicine is to be depleted based on the schedule.

In some embodiments, the schedule is recalculated when a dose of the medicine is divided.

In some embodiments, the alert is generated if a dose is administered off the schedule, an excessive dose is administered, or of there are contradicting medicines and adjustments of schedule.

In some embodiments, the schedule adjustment module includes a rules engine that generates a scheduling adjustment signal according to a user-defined rule, and wherein the schedule is modified in response to the scheduling adjustment signal.

In another aspect, provided is a method for scheduling an administering of a medicine, comprising: allocating, at a medicine container, at least one dose of prescribed medicine for a patient; generating an identification associated with the prescribed medicine and the patient, the identification co-located with the medicine at the medicine container; generating medication scheduling information for the administration of the at least one dose of prescribed medicine; associating the medication scheduling information with an identification; scanning, by an administrator of the at least one dose of prescribed medicine, the identification to retrieve information that the system associated with the medicine; providing the medication scheduling information to a scheduler; and generating from the scheduler an alert regarding when the patient is to take medicine, or an alert regarding a scheduling modification or scheduling error.

In some embodiments, the scheduling information includes a change in a schedule for administering the prescribed medicine in response to a change in the at least one dose of the prescribed medicine.

In some embodiments, the method further comprises generating event data that the at least one dose of the prescribed medicine is administered to the patient; and outputting an alert to an electronic device of the patient in response to generating the event data, wherein the alert includes a time, amount, and name of medicine.

In some embodiments, the alert is generated if the at least one dose is administered off schedule, an excessive dose is administered, or of there are contradicting medicines and adjustments of the schedule.

In some embodiments, the method further comprises modifying the medication scheduling information including generating a scheduling adjustment signal according to a user-defined rule, wherein the schedule is modified in response to the scheduling adjustment signal.

In some embodiments, the method further comprises further overriding, by an electronic device of a non-medical person, the schedule.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a block diagram of a medicine administration environment, in accordance with some embodiments.

FIG. 2 is a block diagram of a scheduling system of FIG. 1, in accordance with some embodiments.

FIG. 3 is a flowchart of a method for scheduling an administering of a medicine, in accordance with some embodiments.

FIG. 4 is a flowchart of a method for adjusting a schedule to accommodate a change in administration of medicine, in accordance with some embodiments.

### DETAILED DESCRIPTION

In the following description, specific details are set forth although it should be appreciated by one of ordinary skill in the art that the systems and methods can be practiced without at least some of the details. In some instances, known features or processes are not described in detail.

A person may require medicine that is prescribed or recommended by the doctor or other qualified professional. Many pharmacies offer online programs that include patient profile information, prescription history data, refill options, drug information, and so on. Typically, after a pharmacy fills a prescription for a customer (e.g., the doctor's patient), the patient or a person acting on the patient's behalf will either pick up the prescription at the pharmacy and physically bring the prescription, which includes the medicine in a bottle, tube, or other container, or provide instructions for home delivery.

Systems and methods are provided that reduce the number of errors related to prescribed medicine or the like dispensed at schools or other facilities where a person such as a child may receive prescribed medicine by correctly identifying the person for receiving the medicine dispensed by a caregiver. A feature of the systems and methods is that receives inputs regarding changes in medicine administration, and automatically changes a current schedule to a new schedule based on the corresponding changes in a planned medicine administration. The schedule can automatically adjust to a change in a dose amount, time, food intake, and so on. This feature permits authorized school staff or other caregiver, for example, a non-medical person, or a medical professional such as a school nurse to use a personal electronic device such as a smartphone identify what medications belong to which patient, and when to administer the medication. An off-the-shelf scheduler used by the school or organization, which either interfaces with the pharmacy server to download the initial schedule, or which permits the user to download a schedule provided by the system. A related feature is that the schedule can automatically adjust to a change in a dose amount or time, as well as react to external factors food intake, split doses, and so on. Another feature is that a current schedule can be modified or overridden at any time by a non-medical user designated by the patient. Notifications are automatically generated that inform a user-specified audience of such scheduling changes. Therefore, the schedule adjusts according to the foregoing factors to ensure that a correct dose (i.e., not an overdose or underdose) is administered on time to the recipient.

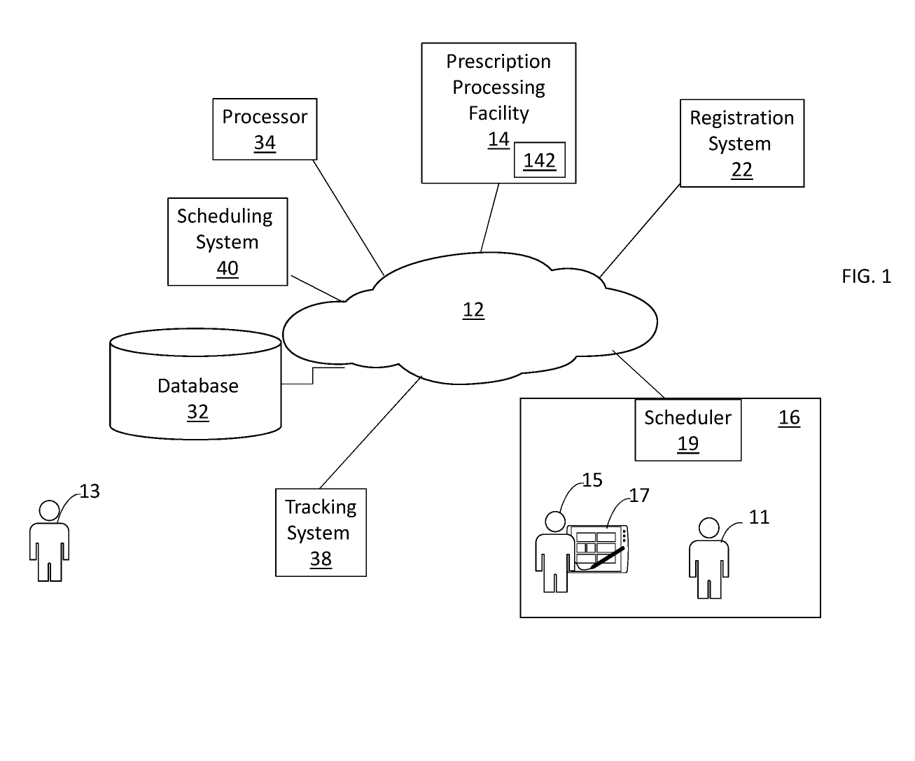

FIG. 1 is a block diagram of a medicine administration environment, in accordance with some embodiments. The medicine administration environment includes a communication network 12 that permits the various entities of the environment to communicate with each other. Entities can include a prescription processing facility such as a pharmacy 14 and a school 16 or other facility at which a caregiver 15 provides prescribed medicine to an intended medicine recipient 11. Although the caregiver 15 and intended medicine recipient 11 are referred to as different people, they can be the same person. For example, the medicine recipient 11 can be adult who can administer doses of medicine. The medicine can be a medication that is prescribed by a doctor or other medical professional, or the medicine can be an over-the-counter medicine such as aspirin or cough medicine.

The medicine administration environment includes functional components for performing various operational steps related to medicine administration-related notifications, including but not limited to a registration system 22, a scheduling system 40, a database 32, at least one processor 34, and a tracking system 38. Some or all of the functional components can be co-located at the pharmacy 14 and/or school 16, or can be geographically separate at a separate location, and can communicate with each other and/or the pharmacy 14 and/or school 16 via the network 16, for example, a public switched telephone network (PSTN), a mobile communications network, a data network, such as a local area network (LAN) or wide area network (WAN), or a combination thereof, or other communication network known to those of ordinary skill in the art. In addition to the caregiver 15 and intended medicine recipient 11, other interested parties such as a parent 13 or guardian of the intended medicine recipient 11, and/or a doctor or other party (not shown) may each have an electronic computer device such as a smartphone, laptop, and so on, for communicating with the various functional components for performing one or more functions related to the administration of medicine to the intended medicine recipient 11.

The pharmacy 14 and the school 16 can each register with a medicine administration program at the registration system 22. Each intended medicine recipient 11 eligible to provide consent (for example, over 18 years old), and/or parent 13 or guardian, and/or caregiver 15 representing the intended medicine recipient 11, may enroll at the program at the registration system 22. To access the registration system 22, the entities (school, pharmacy, guardian, parent, and so on) can have an application installed on the electronic device to identify the entities for security purposes. Enrollment in this manner permits the parent 13, guardian, or other representative of the recipient 11 to authorize access to medical data regarding the recipient 11. In this manner, the parent 13 or guardian to authorize the caregiver 15 to access this information via the program. Also the parent 13, guardian, or other custodian of the intended medicine recipient 11 may register with the program in order to be authorized to access information from the pharmacy 14. When a parent 13 registers, the parent 13 can enroll dependents such as the child recipient 11, whereby medical information on the dependents are accessible for generating notifications, described below.

The program permits communication between the entities by permitting caregiver 15 and/or parent 13, and/or other school official, to identify which medications belong to which patients, when to administer the medications, to determine a delivery route from the pharmacy 14 and the school 16, and so on. For example, a registered parent 13 can receive via the program a list of participating pharmacies, and select a pharmacy for providing the prescribed medicine to the intended medicine recipient 11. In another example, the program may provide features for permitting a participant to keep track of which prescriptions must be refilled, and the dates at which a refill is to occur. In a medicine refill program, the recipients' medicine can be supplied to the school 16 for administering to the intended medicine recipient 11 by the caregiver 15. Information about the intended medicine recipient 11, the medicine, dosage, delivery, and so on can be entered at the registration system 22, and collected and stored in the database 32. Other information is gathered during enrollment at the registration system 22 can include information gathered by the pharmacy 14, such as medicine details, administration instructions such as taking the medicine after a meal, dosage amount, and so on.

When filling a prescription for a medicine, a pharmacist places the prescribed medicine into a bottle or other appropriate container. In embodiments where the recipient 11 is a new customer of the pharmacy 14, a recipient identification (ID) code, also referred to as a medication code, is generated for the new recipient 11, or to the parent, guardian, or authorized representative of the recipient 11. A software application at the server 142 assigns a unique ID code corresponding to the intended medicine recipient 11 and/or the recipient's parent or guardian 13. A medical data file, or customer record, is also created for the recipient 11, for example, including patient name, address, or other identification information. The medical data file can be formed with the ID code, for example, at the pharmacy server 142. The contents of the medical data file can be stored in the database 32. Additional information can be added via an application on a mobile electronic device 17 such as a smartphone or the like. When the recipient ID code is created for a prescription by the pharmacist, the ID code is placed on the container holding the prescribed medicine, the recipient ID code can link and uniquely identify the filled prescription of the customer to a customer's medical data file or record stored on the pharmacy server 142 and/or at the database 32 at a remote location. Other information can also be linked to the ID code and medical data file such as instructions for taking the medicine. The user such as caregiver 15 can be directed to the patient identification, for example, a digital photograph, and user menu once logged into the system

If the intended medicine recipient 11 is an existing customer requiring a refill, then preferably the same ID code is used for all prescription data belonging to the recipient 11. Here, the pharmacist verifies that the container for refill matches the prescription by scanning or otherwise reading the label on the selected container. Alternatively, a separate ID code can be assigned to the recipient 11 for each separate prescription. The recipient ID code is printed or otherwise marked or added to the container, to a label on the container, or onto an attached document such as instructions for taking the medicine.

The recipient ID code and the label for the container are preferably printed at the same time to ensure that the correct ID code is attached to, marked upon, or otherwise accompanying, the container for each individual prescription. Any type of ID code can be used that can be accessed by way of any known method, such as but not limited to, a scannable barcode, a QR code, a magnetic strip code, an OCR (optical character recognition code), an encrypted code, standard alpha-numerical characters, a code identifiable by digital imaging, or any other code. The ID code can store URLs or other information, which can point to the customer's medical data. For example, the ID code can include a web page address, or uniform resource locator (URL) for the customer's patient prescription for a specific patient. The ID code can be read by a camera on a caregiver mobile device 17 or other code-reading device such as a barcode reader or scanner for reading printed barcodes such as a barcode or QR code from the label of the container.

As described above, if the prescription being filled is for a new customer, then a new customer record can be created, which is linked for access to the customer's ID code and stored in the database 32. If a medical data file for the customer already exists in the database 32, then the new prescription data can be added to the customer's existing medical data file. The pharmacist can also set up login information for a new customer such as a user name and password to allow the customer, after the prescription has been filled, to be able to login at a pharmacy website available on the Internet (which can include network 12). Alternately, the customer could use the assigned ID code along with an identifier such as a name and/or other identifying data to create a new account.

In addition to the customer's personal information, the pharmacist can enter other information in predetermined entry fields mapped to the customer's medical data file such as information identifying the customer's prescribed medicine, dosage, and the name of the doctor who is prescribing the medicine. The medicine can be prescribed for a specific time period and a specific number of refills, such as 30 pills to be refilled once a month for a period of one year.

Other information may include the medical history, clinical outcomes, and allergic reactions to certain types of drugs and similar kind of information related to the patient, which can be obtained via the network 12 from other sources of patient data.

Also, at the time of the fill, the pharmacy 14 may take or receive a digital image or photograph or other identifier of the intended medicine recipient 11, which can be stored with the recipient's medical data file at the database 32 which is mapped to the recipient ID code by the processor 34. The digital image identifier can be used for biometric scanning such as facial recognition. Other biometric attribute data can alternatively be captured in addition to, or instead of, a photo id, such as data for performing a fingerprint scan, retina scan, iris scan, voice recognition, biochemical identifiers, and so on.

Other information such as medicine prescription data, dose quantity, route of administration, incremental times that authorized caregiver may dispense the medicine, contact information such as text number, email, or alternative method of notification, and so on can likewise be linked to the ID code and stored at the database 32. For example, when the caregiver mobile device 17 detects an issue, it can notify a central computer through the network 12. The central computer can output a communication (i.e., text, email, and so on) to the user-defined notification recipient, along with information such as patient information (name, data, medication, type of issue, and so on). Some or all of the data can be printed and attached to the bottle or other container holding the prescribed medicine.

After a prescription is filled, the container holding the prescribed medicine is delivered to the school 16. Here, the parent 13 or a person acting on behalf of the intended recipient 11, or the recipient 11 himself or herself, can either pick up the prescription at the pharmacy 14, or provide delivery instructions, for example, by entering the instructions into a computer that are electronically transmitted directly to the pharmacy server 142, or to the program's website or the like which communicates with the pharmacy server 142, or via the database 32 which stores the instructions with the medical data file corresponding to the recipient 11.

The caregiver 15 can verify the identity of the intended medicine recipient 11 by visually comparing a photograph or other identifier of the intended medicine recipient 11 on the medicine container and/or a digitized photograph or the like that is displayed on the smartphone 17 after scanning the ID code. For example, the caregiver 15 can use a smart device 17 or the like to scan the ID code on the medicine container, visually inspect a photograph of the intended medicine recipient 11 on the medicine container to ensure that the right medicine is administered to the right person. In other embodiments, a fingerprint, retinal scan image, or other biometric identifier may be taken of the recipient 11 and compared by the processor 34 to previously captured biometric data corresponding to the recipient ID code and stored at the database 32. As described below, notification can be generated when the processor 34 determines that the biometric data does not match the identification on the medicine container.

Tracking system 38 receives data generated from the scan by the caregiver mobile device 17, which can be used for monitoring the administration of medicine, and for tracking how well the caregiver 15 does with the administration of medicine. For example, after the ID code is scanned, the caregiver 15 can press an acknowledgement button or other triggering element on the mobile device 17 which confirms that an action was taken, for example, that the intended recipient 11 consumed a dose of medicine. Details such dose quantity, time of consumption, and so on can also be received and processed. For example, the tracking system 38 may establish that the guardian provided 2 pills, or missed a 4 hour window, which can be recorded by the tracking system 38 for future reporting, for example, on the caregiver's administration record.

The scheduling system 40 permits scheduling adjustments to occur with respect to the administration of medicine to an intended medicine recipient 11. For example, the scheduling system 40 allows an authorized party such as a caregiver 15 to make changes to a dose amount, time of administration, and so on, whereby the schedule can automatically adjust according to such changes. If the change is determined to be incorrect, for example, if the route of administration or adjusted dose amount is incorrect, then an error message can be generated that is output to a predetermined notification recipient audience. The scheduling system 40 can also override a current schedule, for example, when a user disagrees with a scheduled dose amount or time for administering the dose amount.

The scheduling system 40 can generate a medicine allocation schedule from data collected from the pharmacy server 142 and/or the database 32, which can be loaded into a scheduler 19 at the school 16 or other facility at which the recipient 11 receives prescribed medicine from a caregiver 15. The school scheduler 19 can be an off-the-shelf scheduler, for example, Microsoft Outlook Calendar™ scheduler, or a proprietary scheduler using an application programming interface (API). Alternatively, users can download an application that is executed on the user's computer to access and use the scheduling software of the pharmacy server 142.

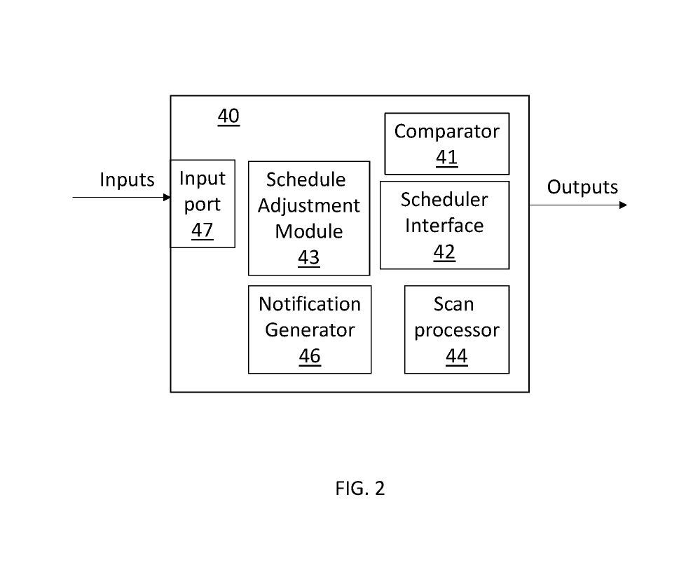

FIG. 2 is a block diagram of the scheduling system 40, in accordance with some embodiments. The scheduling system 40 can include a comparator 41, a scheduler interface 42, a schedule adjustment module 43, a scan processor 44, and a notification generator 46. Some or all of the elements of the scheduling system 40 can reside together locally at a single site or can be distributed over two or more separate sites and communicate with each other via the network 12.

The scheduling system 40 includes an input port 47 that receives event data, for example, a time, amount, and name of medicine provided by the caregiver 15 to the recipient 11. Current event data such as a current dose amount and current time of administration can be captured by the caregiver 15 selecting a button or the like at the smartphone 17 after administration, whereby this data is input to the scheduling system and/or stored at the database 32 as historical event data. The input port 47 can also receive information from the database 32, for example, medicine instructions, scheduling information that includes times, etc. for administering medicine. The input port 47 can receive schedule change requests, override signals or the like, for example, generated from the caregiver mobile device 17, or other schedule alteration requests.

The comparator 41 compares the current event data (current time, dose of administration, and so on) with the current schedule, and generates a comparison result that can be stored at the database 32 and used for performance reviews. For example, statistical data can be generated regarding the percentage of time that the caregiver 15 administers medicine on time. For example, a schedule may indicate that a dose of medicine is to be administered every four hours and the caregiver 15 correctly administered the dose of medicine every four hours all but four times during the prescribed period of 30 days. The users of the system can therefore evaluate the statistical data on administration performance. A log may be maintained, for example, at database 32 or other data repository, all actions. This log can be parsed into data points which are evaluated. From this, visualizations such as bar or line charts can be generated and displayed, for example, to show expected results compared to actual results over time.

As described herein, a caregiver 15 can use a computer device such as a smart phone to scan the ID code to retrieve information that the system associates with the medicine when it arrives at the school 16. In doing so, the schedule and patient information can be loaded by the scheduler interface 42 into the organization's schedule so that the organization can receive alerts when the patient is to take medicine and customer receive alerts if medicine is not filled on schedule. The school 16 can receive alert by the by the schedule loaded into the school's scheduling software. The system may include the mobile application, web application, network 12, and pharmacy servers 142 and database 32. A customer may use the system to authorize the caregiver 15 such as a school nurse to see the medical information associated with the intended medicine recipient 11. When the system receives the authorization, the system then retrieves the patient information and makes it available to the authorized user. All information may be stored at the pharmacy server 142.

The schedule adjustment module 43 can modify or override a current schedule, for example, when determining that two medicines contradict each other, or for any reason determined by an authorized caregiver 15. Specific overrides can include overriding a scheduled quantity, dose, time, and/or location of administering medicine. A notification may be generated to a user-defined recipient audience in response to a schedule override. The system can adjust an off the shelf scheduler 19, such as Microsoft Outlook Calendar. Here, the mobile application or web application on the mobile device 17 can serve as a source for information and compliance. The mobile application and off-the-shelf scheduler 19 can synchronize with each other using API calls or the like. The off-the-shelf scheduler 19, for example, Microsoft Outlook, provides a way for viewing scheduling information. However, the processing of schedule data is performed in the application on the mobile device 17 and/or pharmacy server 142. For example, the application through the pharmacy server may send notifications (described herein) in the form of email, text, IM, voice, or a message on the mobile application or web application on the mobile device 17.

The schedule adjustment module 43 may include a rules engine that generates a scheduling adjustment signal according to a recipient, physician, pharmacist, or other user-defined rule. For example, the rules engine may establish (for example, from the pharmacy server 142 or contents of the database 32) that the recipient 11 is scheduled to receive two different medicines, which cannot be taken by the recipient 11 within four hours of each other. The schedule adjustment module 43 can modify the schedule at the scheduler 19, for example, via API calls, so that the two medicines are not taken within four hours of each other. Alternatively, a user can override the schedule in cases where the current schedule does not comply with the rule, for example, where the two medicines are currently scheduled to be administered at the same time. Here, a user can override the schedule, for example, so that the second medicine is rescheduled for being administered outside of the four hour requirement.

The scan processor 44 receives and processes data encoded on the recipient ID code on the medicine container, for example, QR code. For example, the scan processor 44 can communicate with a scanner on the smartphone 17 of the caregiver 15. The scanned data on the recipient ID code can be used to retrieve contents of the medical data of the recipient 11 stored at the database 32. This includes a medicine allocation schedule, which can be loaded into the scheduler 19 at the school 16 or other facility at which the recipient 11 receives prescribed medicine from a caregiver 15. In doing so, the school 16 can receive alerts when the patient is about to receive medicine so that school representatives such as the caregiver 15 can ensure that the recipient 11 is available for receiving the scheduled dose of medicine. The parent 13 or guardian and/or recipient 11 can receive alerts or other informational notifications if the medicine is not filled, or a dose is not administered on schedule, if recipient 11 misses a scheduled dose of medicine, if inventory supplies of the medicine are scheduled to run out, and so on.

The notification generator 46 facilitates the distribution of scheduler-related notifications, for example, alarms, warnings, or other informational notifications. For example, a notification can be provided as medicine is taken or when a scheduled time for taking a medicine is exceeded, or otherwise not taken according to a predetermined schedule.

The notification generator 46 can be configured to send notifications in the form of emails, text messages, voice messages, face time, IVR, database updates, regular mail (non-electronic communication), or other form of communication to one or more user-defined notification recipients, for example, parents, school officials, emergency contacts, and so on, when exceptions to a predetermined medicine administration occur. The email addresses, phone numbers, or other notification data can be stored at the pharmacy server 142 or the database 32. The notification recipients can be identified by the intended medicine recipient 11, the caregiver 15, the parent 13, or other authorized person. Contents of notifications can be automatically inserted into a message, for example, predefined and stored at the database 32 or other data repository. Alternatively, user-defined notifications can be generated. For example, an authorized system user can type and output the text for a particular notification to the notification generator 46.

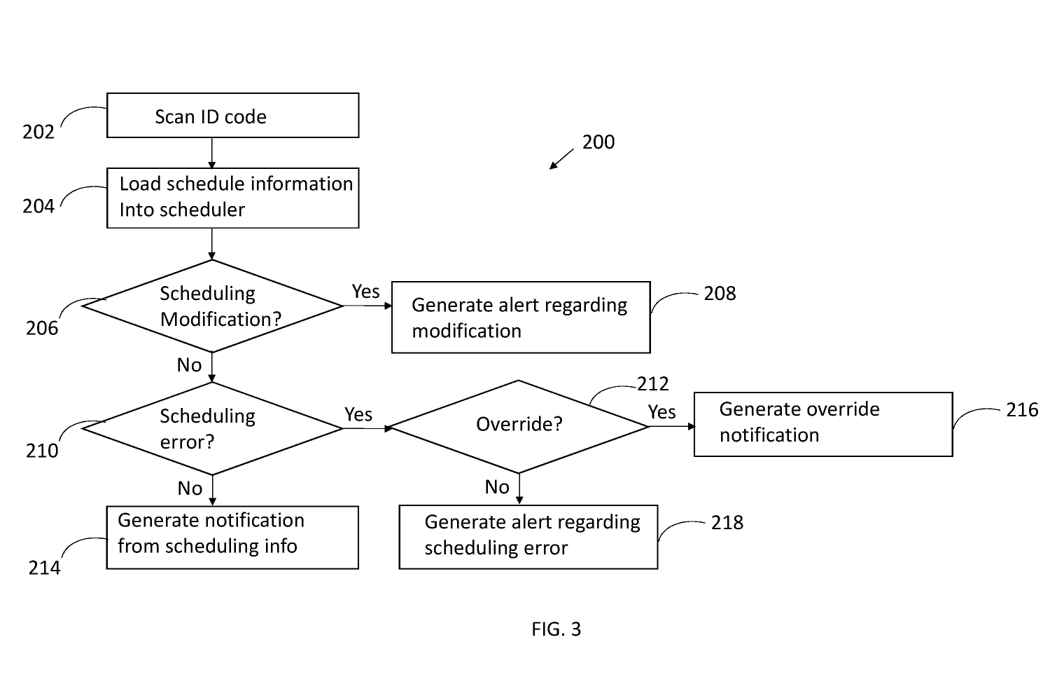

FIG. 3 is a flowchart of a method 200 for scheduling an administering of a medicine, in accordance with some embodiments. In describing the method, reference is made to FIG. 1. Some or all of the method can be executed by elements of the medicine administration environment of FIG. 1.

At block 202, a recipient ID code on a medicine container is scanned by a person responsible for administering medicine to a recipient 11, for example, a guardian 15. The scanned data on the recipient ID code can be used to retrieve contents of the medical data of the recipient 11 stored at the database 32. This includes a medicine allocation schedule.

At block 204, the medicine allocation schedule can be loaded from the database 32 or pharmacy server 142, assuming that authorization is provided by the parent 13 or guardian of the recipient 11, into the scheduler interface 42 of the scheduling system 40, then transferred into a scheduler 19 at the school 16 or other facility at which the recipient 11 receives prescribed medicine from a caregiver 15. An alert can be generated when the schedule is retrieved so that a predetermined set of notification recipients, such as parent 13, guardian 15, and/or other authorized people, may be notified when medicine is scheduled to be administered.

At decision diamond 206, a determination is made whether a scheduling modification has been made. For example, a doctor providing a prescription may modify an original schedule instructing the recipient 11 to take a dose of medicine every 4 hours instead of every 2 hours. This can be achieved by the modification to first be entered in the pharmacy server 142 or other system, whereby the schedule adjustment module 43 receives the notification. For example, a prescription change may be given to the pharmacist by the customer (parent 13) from the recipient's doctor. However, the system assumes that the customer has given the doctor access to the application and the doctor has access to the application, hereby the doctor could make the change through the application to the pharmacy server 142. In other embodiments, the customer or the pharmacist can make a change. Once the change is in the system, the system can synchronize the data to the applications used by the users, either through a push transaction or through the users' applications accessing the data through a pull. Alternatively, the schedule may be changed by the parent 13, guardian 15, or other authorized person, who may modify or override the schedule at the school 16 so that the recipient 11 receives the doses at different times, but with no changes to quantity or dose between times as with the previous example.

If a scheduling modification is made, then the method proceeds to block 208, where an alert is generated regarding the modification and output to one or more user-defined notification recipients. Otherwise, the method 200 proceeds to decision diamond 210, where a determination is made whether a scheduling error occurred. A scheduling error may be a medicine administration error, such as a missed dose, not administered at its scheduled time. Another scheduling error may pertain to the incorrect time for administering a dose of medicine. If a scheduling error is not determined, then the method 200 proceeds to step 214, where a notification can be generated regarding the schedule, for example, that a dose of medicine is scheduled to be administered. The notification can include a time, amount, name, or other information regarding the administration of medicine to the intended recipient 11.

If at decision diamond 210 a scheduling error is determined, then the method 200 proceeds to decision diamond 212, where a determination is made whether an override is generated. An authorized user such as caregiver 15, parent 13, doctor, or pharmacist may override a current schedule for any reason related to the administration of the medicine to the intended medicine recipient 11, for example, to change a quantity of medicine during a scheduled administration of the medicine. If a scheduling override occurs, then the method 200 proceeds to step 216, where an override notification is generated. Otherwise, the method 200 proceeds to step 218, where a scheduling error alert is generated.

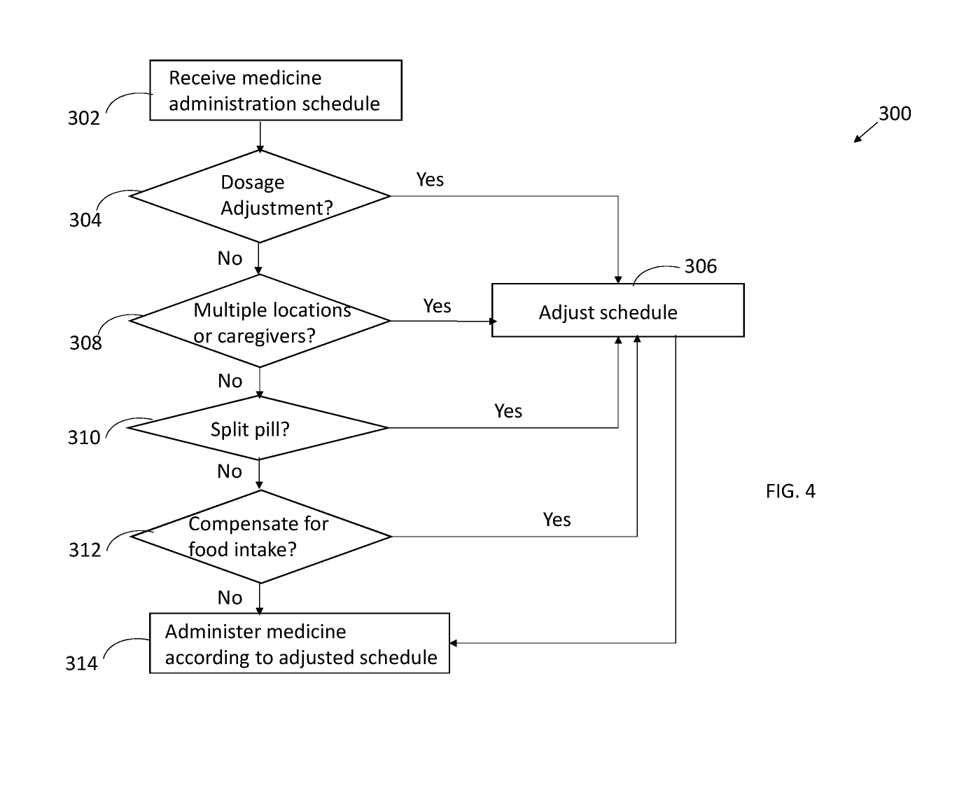

FIG. 4 is a flowchart of a method 300 for adjusting a schedule to accommodate a change in administration of medicine, in accordance with some embodiments. In describing the method 300, reference is made to FIG. 1. Some or all of the method 300 can be executed by elements of the medicine administration environment of FIG. 1.

At block 302, a medicine administration schedule is received, for example, by a caregiver 15. The medicine administration schedule can be provided at a user interface of the smartphone 17, or a website, or software application at a computer at the school 16. The schedule includes days, times, and/or related data regarding the administration of medicine at the school 16, for example, provided by the pharmacy 14.

At decision diamond 304, a determination is made whether a scheduled dose of the medicine requires adjustment. The dose can refer to an amount of medicine determined by a doctor or other authorized professional originally part of a prescription. A dose adjustment may refer to an amount of a dose, or a time during which a dose is scheduled to be administered, for example, according to administration instructions provided with the customer medical record linked to the recipient ID code stored at the database 32. A dose adjustment may be made proactively by the caregiver 15 or other authorized person, such as a pharmacist or doctor. In other embodiments, a dose adjustment may be made automatically, to accommodate food intake, to match meals, or to administer on an empty stomach. This information may be provided with the medicine instructions, or entered into the system, whereby this information can be provided to the schedule adjustment module 43, which can adjust the schedule according to this information. The system is flexible for situations when unexpected events occur while permitting the adjustment to a schedule to accommodate the situation. Notifications may be generated for user-defined recipients regarding either unexpected events or planned or predetermined events.

In some embodiments, the caregiver 15 may alter or override the schedule, even after the system computes or recomputes the schedule according to dose adjustments. When the caregiver 15 overrides a schedule adjustment, a notification may be generated to one or more user-defined notification recipients.

If at decision diamond 304 a scheduled dose is determined to require an adjustment, then the method 300 proceeds to block 306, where the schedule is adjusted to correspond to the dose adjustment, for example, to ensure that the dose is misadministered, for example, over-prescribed or under-prescribed. The schedule can be adjusted for a particular event, for example, in response to information indicating that the recipient 11 will not be eating a meal on a particular day. The schedule can be modified for all upcoming doses, for example, changing all nightly doses to accommodate for the recipient's 11 sleep schedule.

If at decision diamond 304, a determination is made of no dose adjustment, then the method 300 proceeds to decision diamond 308, where a determination is made whether the administering of medicine may occur at different locations, for example, at different time zones, or by different caregivers, each using a different smartphone 17 for scanning the recipient ID code on the same medicine container. The pharmacy server 142 communicates with the processor 34 or tracker 38 and/or with the different smartphones 17, so that each caregiver 15 is informed as to dosage amounts that are administered by each other. For example, the mobile applications, web applications, and scheduling software of the system communicate with the pharmacy server for exchanging scheduling-related data. In doing so, each application may check with the server 142 for updates. The pharmacy server 142 may either push relevant data to all registered applications, and/or the applications may retrieve the information from the server 142.

If it is determined that the medicine is to be administered at different locations and/or by different caregivers, then the method 300 proceeds to block 306, where the schedule is modified, for example, to identify the caregiver administering the medicine at each timeslot, or to accommodate for time zone changes, and so on. Otherwise, the method 300 proceeds to decision diamond 310, where a determination is made whether a dose of medicine is to be split, or divided to be administered at different times to the intended recipient 11. For example, a doctor may prescribe a dose in the form of a pill that is twice the amount. Here, the caregiver 15 must divide the pill requiring a schedule change due to the doubled number.

If at decision diamond 310, a determination is made that a dose is to be split, then the method proceeds to block 306, where the schedule can be recalculated to accommodate for the split pill condition. For example, an original schedule may call for the dose to be administered every 4 hours. However, if the dose is determined to be twice as large as the prescribed dose, then the schedule is modified to create for two different administering periods, each 4 hours apart. Otherwise, if the pill is the prescribed dose, then each portion of the split pill may be administered 2 hours apart. By prescribing the larger pill and splitting it, the patient can have two doses from the larger pill, which is less expensive than purchasing two smaller pills.

At decision diamond 312, a determination is made whether food intake factors are to be considered, for example, whether medicine is to be administered after eating a meal, or taken on an empty stomach, or to correspond with mealtime. The caregiver 15 may submit this information via the mobile device 17 into the system which keeps the pharmacy server up to date. If food intake factors are to be considered, then the method 300 proceeds to block 306, where the schedule is modified. The schedule may be modified due to events other than or different than those illustrated in decision diamonds 304, 308, 310, and 312. For example, two different medicines, each scheduled to be administered to the recipient 11, may be known to cause side effects. This information may be known at the pharmacy 14, and may be provided via the system to the caregiver 15. In some embodiments, the schedule may be automatically modified. In some embodiments, the pharmacy server 142 will evaluate the data it has on hand for each customer and notify the customer and whomever the customer has authorized. The caregiver 15 may in turn override the schedule, instead of relying on an automatic scheduling adjustment. At block 314, the scheduled dose of medicine is administered.

As will be appreciated by one skilled in the art, concepts may be embodied as a device, system, method, or computer program product. Accordingly, embodiments may take the form of an entirely hardware embodiment, an entirely software embodiment (including firmware, resident software, micro-code, etc.) or an embodiment combining software and hardware embodiments that may all generally be referred to herein as a “circuit,” “module” or “system.” Furthermore, embodiments may take the form of a computer program product embodied in one or more computer readable medium(s) having computer readable program code embodied thereon.

Computer program code for carrying out operations for the concepts may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. A scheduling system, comprising:
an input port that receives from a caregiver electronic device data generated from a medication code corresponding to a prescribed medicine for a patient and that further receives medication scheduling information associated with the medication code for an administering of the prescribed medicine to the patient;
a schedule adjustment module executed by a hardware processor and configured to receive and process data from the input port regarding a modification to the medication scheduling information;
a notification generator that outputs an alert related to the modified medication scheduling information; and
a display for displaying a schedule generated from the medication scheduling information.

2. The scheduling system of claim 1, wherein the notification generator uses the medication code to retrieve a patient identification that is displayed by the scheduler notification engine with a next scheduled time for administering a dose of the prescribed medicine to the patient.

3. The scheduling system of claim 1, wherein the modification to the medication scheduling information includes a change in a schedule for administering the prescribed medicine in response to a change in a dose of the prescribed medicine.

4. The scheduling system of claim 3, further comprising a user interface at the display that permits a user to change a quantity of the prescribed medicine, and wherein the schedule is modified to ensure that the quantity is not over or under a threshold.

5. The scheduling system of claim 1, wherein the notification generator outputs the alert to an electronic device of the patient when the caregiver generates event data that a dose of the prescribed medicine is administered to the patient, and wherein the alert includes a time, amount, and name of medicine.

6. The scheduling system of claim 5, further comprising a comparator that compares the event data and the medication scheduling information for performance reviews.

7. The scheduling system of claim 1, wherein the processor processes the medication scheduling information related to multiple patients with multiple medicines which need to be administered at different times.

8. The scheduling system of claim 7, wherein the scheduler notification engine modifies the medication scheduling information in response to different caregivers administering the prescribed medicine to the patient from different locations.

9. The scheduling system of claim 1, wherein the scheduler notification engine adjusts the schedule according to whether the medicine is to be administered with food.

10. The scheduling system of claim 1, wherein the schedule is recalculated based on when a dose of the medicine is taken.

11. The scheduling system of claim 1, wherein the alert includes a warning when a supply of the medicine is to be depleted based on the schedule.

12. The scheduling system of claim 1, wherein the schedule is recalculated when a dose of the medicine is divided.

13. The scheduling system of claim 1, wherein the alert is generated if a dose is administered off the schedule, an excessive dose is administered, or there are contradicting medicines and adjustments of schedule.

14. The scheduling system of claim 1, wherein the schedule adjustment module includes a rules engine that generates a scheduling adjustment signal according to a user-defined rule, and wherein the schedule is modified in response to the scheduling adjustment signal.

15. A method for scheduling an administering of a medicine, comprising:
allocating, at a medicine container, at least one dose of prescribed medicine for a patient;
generating an identification code associated with the prescribed medicine and the patient, the identification code co-located with the medicine at the medicine container;
generating medication scheduling information for the administration of the at least one dose of prescribed medicine;
scanning, by an administrator of the at least one dose of prescribed medicine, the identification code to retrieve the medication scheduling information;
providing the medication scheduling information to a scheduler; and
generating from the scheduler an alert regarding when the patient is to take medicine, or an alert regarding a scheduling modification or scheduling error.

16. The method of claim 15, wherein the scheduling information includes a change in a schedule for administering the prescribed medicine in response to a change in the at least one dose of the prescribed medicine.

17. The method of claim 15, further comprising:
generating event data that the at least one dose of the prescribed medicine is administered to the patient; and
outputting an alert to an electronic device of the patient in response to generating the event data, wherein the alert includes a time, amount, and name of medicine.

18. The method of claim 15, wherein the alert is generated if the at least one dose is administered off schedule, an excessive dose is administered, or there are contradicting medicines and adjustments of the schedule.

19. The method of claim 15, further comprising modifying the medication scheduling information including generating a scheduling adjustment signal according to a user-defined rule, wherein the schedule is modified in response to the scheduling adjustment signal.

20. The method of claim 15, further comprising overriding, by an electronic device of a non-medical person, the schedule.
